(19) United States
(12) Patent Application Publication
(10) Pub. No.: US 2025/0376036 A1
(43) Pub. Date: Dec. 11, 2025

(54) HYDRAULIC SYSTEM FOR A DYNAMIC ENERGY TRANSFER SYSTEM

(71) Applicant: Caterpillar Inc., Peoria, IL (US)

(72) Inventors: Steven E. JOHNSON, Metamora, IL (US); Dennis D. RANKIN, Oro Valley, AZ (US); Maitreya V. LAGADAPATI, Peoria, IL (US); Darshan C. PATEL, Des Plaines, IL (US)

(73) Assignee: Caterpillar Inc., Peoria, IL (US)

(21) Appl. No.: 19/217,591

(22) Filed: May 23, 2025

Related U.S. Application Data
(60) Provisional application No. 63/657,582, filed on Jun. 7, 2024.

(51) Int. Cl. B60L 5/32; F15B 13/02; F15B 15/14

(52) U.S. Cl. CPC B60L 5/32; F15B 13/02; F15B 15/14

(57) ABSTRACT

A rail connector assembly for an electrically powered mobile machine includes a boom assembly with a first end and a second end, and an arm assembly movable between a stowed condition and a deployed condition. The arm assembly includes a first end coupled to the boom and a second end. A contactor assembly is coupled to the second end of the arm assembly. The system further includes a hydraulic system controlling movement of the rail connector assembly. The hydraulic system includes a hydraulic power unit, a plurality of hydraulic actuators fluidly driven by the hydraulic power unit, and at least one float valve fluidly connected to at least one of the plurality of hydraulic actuators.

### CROSS-REFERENCE TO RELATED APPLICATION

This application claims the benefit of priority to U.S. Provisional Patent Application No. 63/657,582, filed on Jun. 7, 2024, the entirety of which is incorporated herein by reference.

### TECHNICAL FIELD

The present disclosure relates generally to a dynamic energy transfer system for a mobile machine and, more specifically, to a hydraulic system for controlling a rail connector assembly of a dynamic energy transfer system.

### BACKGROUND

Mobile industrial machines, such as earth-moving machines, can be of substantial weight and can bear immense loads, thus requiring a large amount of power. Many industrial machines are driven by internal combustion engines. However, internal combustion engines have drawbacks such as fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present challenges. For example, the use of hybrid or all-electric systems in an industrial capacity requires a significant investment in infrastructure, particularly due to the location of industrial worksites. While the use of overhead electricity-conducting lines is one solution for powering vehicles with predetermined routes or terrain (e.g., trains, subways, buses, etc.), overhead lines are not practical for all machines or worksites, such as freely-steerable industrial machines and worksites with uneven terrain. As a result, existing power systems, such as overhead lines, are not typically used in remote and uneven environments. Other problems include the ability to safely deliver electricity to a moving industrial vehicle. It is therefore beneficial for industrial machines to have control systems with the ability to quickly deploy or retract a connector assembly, either manually or automatically, with minimal, if any, assistance from the machine operator.

An electric delivery system for providing electric power to a traveling vehicle is described in International Patent App. Pub. No. WO 2020/186296 A1, published on Sep. 24, 2020 (“the '296 publication”). The system described in the '296 publication describes an electrical delivery system at a mine site for a moving vehicle where two conductors are anchored to relocatable roadside barriers. In order to charge the moving vehicle, the delivery system requires a retractable arm to precisely engage with electrical connectors embedded within a horizontal channel of the roadside barriers. While the system described in the '296 publication may be helpful in some circumstances, the '296 publication does not describe, among other things, a system to easily maintain the connection between the electrical delivery system to the roadside electrical conductors while the mobile industrial machines is moving.

Aspects of the present disclosure may solve one or more of the problems set forth above and/or other problems in the art. The scope of the current disclosure, however, is defined by the attached claims, and not by the ability to solve any specific problem.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electrically-powered mobile machine including a rail connector assembly for coupling with a conductive rail system, according to aspects of the present disclosure.

FIG. 2 is a perspective view of an arm assembly and contactor assembly of the rail connector assembly of FIG. 1.

FIG. 3 is a schematic of a hydraulic system for operating the rail connector assembly of FIG. 1.

FIG. 4 is a flowchart illustrating an exemplary method for controlling the rail connector assembly and hydraulic system of FIG. 3.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

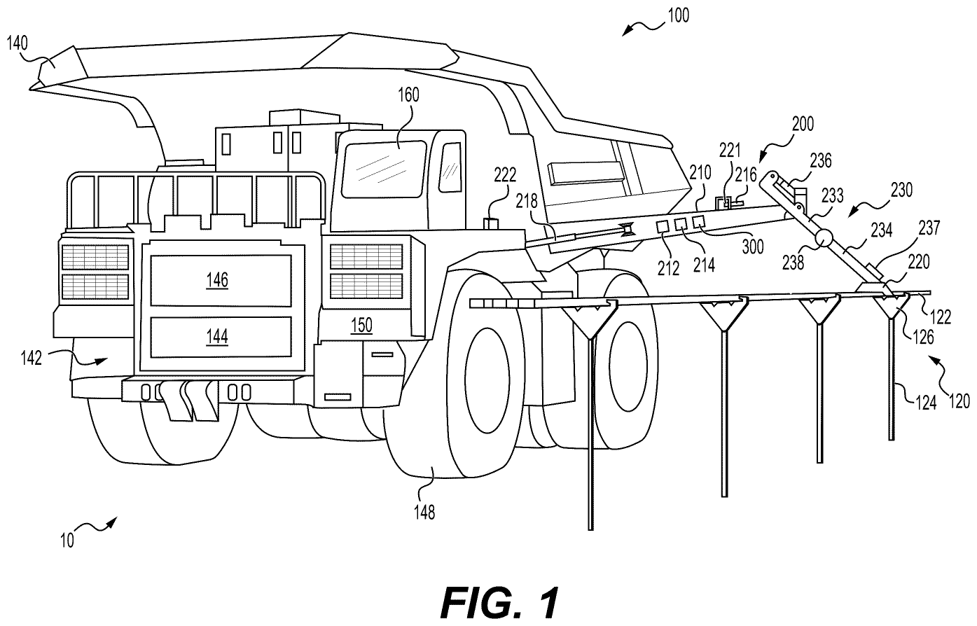

FIG. 1 depicts a mobile machine power system 100 including an electrically-powered mobile machine 140 having an electricity-conducting rail connector assembly 200, and an electricity-conducting rail system 120 for providing electric power to the mobile machine 140. As used herein, the phrase “electrically-powered” or “electric drive” includes machine systems that are entirely electric as well as hybrid machine systems. In a hybrid machine, an internal combustion engine is included to assist with propulsion and/or generation of electric power. An internal combustion engine is omitted in an entirely or all-electric machine.

The mobile machine 140 includes an electric drive system 142 having at least one electric motor 144, and may include at least one battery system 146. The electric drive system 142 drives a set of ground-engaging elements 148, such as tires or continuous tracks, for propelling and maneuvering the mobile machine 140 over the ground 10. The mobile machine 140 also includes a frame/body 150 that supports the mobile machine's mechanical components, including the electricity-conducting rail connector assembly 200. As noted above, mobile machine 140 may include either a hybrid or an all-electric power system, and the electricity-conducting rail system 120 may be applied to either system. Mobile machine 140 and its various systems may be controlled via a machine operator located in the operator cabin 160, and/or mobile machine 140 may be semi- or fully-autonomous or remotely operated.

The mobile machine 140 is free-steering, allowing the operator of the machine (or autonomous control system) to freely control the direction and route of the machine. Thus, the exemplary mobile machine 140 is configured to travel (e.g., in a free-steering manner) selectively along a work route or path within a job site, with the electricity-conducting rail system 120 positioned generally along the route or path. The mobile machine 140 of FIG. 1 is shown in the context of a mining truck which is commonly used for transporting ore in a mine environment. The present disclosure is not so limited, however, and other types of machines are within the scope of the present disclosure, including articulated trucks, asphalt pavers, backhoe loaders, drills, rope shovels, excavators, forest machines, hydraulic mining shovels, material handlers, motor graders, off-highway trucks, pipelayers, road reclaimers, telehandlers, track loaders, underground mining dump loaders and trucks, wheel loaders, wheel tractor-scrapers, or other machines.

The electricity-conducting rail system 120 includes a plurality of elevated conductor rails 122 connected to a power source (e.g., a power grid, generator, and/or energy storage devices, not shown). The conductor rails 122 may be supported by a plurality of ground-engaging support poles 124 and rail bracket assemblies 126. While FIG. 1 shows an example where the plurality of conductor rails 122 contains three conductor rails, the plurality of conductor rails 122 may contain fewer or more rails. In this example, two of the conductor rails provide electrical power at different polarities (e.g., a conductor rail with a positive polarity and a conductor rail with a negative polarity) while the third conductor rail provides a reference of 0 volts (ground). The elevated conductor rails 122 may have a height, for example, in the range of 8 to 15 feet above the ground 10. Thus, the electricity-conducting rail system does not form a pantograph-type overhead power system, nor an under-machine or low-ground-located power system.

The electricity-conducting rail connector assembly 200 electrically connects the mobile machine 140 to the electricity-conducting rail system 120. The electricity-conducting rail connector assembly 200 includes a boom assembly 210 having a proximal end and a distal end; an arm assembly 230, such as a trailing arm assembly, having a first or proximal end connected to the distal end of the boom assembly 210; and a contactor assembly 220 connected to a second or distal end of the arm assembly 230. As used herein, the term “trailing” refers to a direction opposite the forward direction of travel of the mobile machine 140. The contactor assembly 220 is configured to interface with the electricity-conducting rail system 120 through a plurality of conductor terminals.

The rail connector assembly 200 houses, for example, an electricity-conveying system 212, an electronics system 214, and a hydraulic system 300. Electricity-conveying system 212 may include, for example, various busbars, electrical cables, electrical joints, contactors, brushes, etc. Electronics system 214 may include, for example, an electronic control module (“ECM”), a plurality of sensors, a plurality of electronic actuators, etc. Hydraulic system 300 may include a hydraulic circuit including a hydraulic power unit, hydraulic lines, linear and/or rotary hydraulic actuators, etc., which will be described in more detail below. While electricity-conveying system 212, electronics system 214, and hydraulic system 300 are disclosed as being self-contained on or within rail connector assembly 200 to assist in adding rail connector assembly 200 to existing machine designs, it is understood that various components of these systems could be located on the frame/body 150 of the mobile machine 140. Such frame-located components could include, for example, the hydraulic power unit.

Hydraulic system 300 may be configured for pivotably extending, retracting, and locking the boom assembly 210, arm assembly 230, and connector assembly 220. The ECM may be housed within the boom assembly 210 and receive signals from the mobile machine 140 and the sensors within the rail connector assembly 200 to generate commands to the various components of the rail connector assembly 200. For example, in the case of controlling the hydraulic system 300, the ECM may monitor various component and generate and send actuation commands (e.g., electronic signals) to the various components of the hydraulic system 300. In some embodiments, the rail connector assembly 200 may additionally or alternatively include a pneumatic system for generating and controlling one or more pneumatic actuators for controlling aspects of rail connector assembly 200. While the disclosure below will provide details of hydraulic system 300, it is understood that certain components and features may be controlled by a pneumatic system.

As shown in FIG. 1 the boom assembly 210 extends generally horizontally from a side of the mobile machine 140 and is connected to a side of the frame/body 150 of the mobile machine 140 about a pivot joint. The pivot joint is located at a height of over 8 feet on the machine (above the ground 10). While the boom assembly 210 is shown attached to a large mining truck, the same boom assembly 210 is capable of being incorporated onto various types of mobile machines 140 by use of an interchangeable adapter (not shown) that is specific to the type of machine being operated.

As previously referenced, the electricity-conducting rail connector assembly 200 includes several different states of deployment, including an extended or deployed state in which the boom assembly 210 is extended generally horizontally outward away from a side of the mobile machine 140 (as shown in FIG. 1), a retracted or stowed state (not shown) in which the boom assembly 210 is rotated or pivoted inward to rest against the frame/body 150 of the mobile machine, and a locked state in which the boom assembly is locked to the side of the machine frame/body 150 in the retracted or stowed state. Movement of the rail connector assembly 200 may be achieved by a plurality of actuators, such as, for example a boom actuator 218, a lock actuator 216, an upper trailing arm actuator 236, a middle trailing arm actuator 238, and a lower trailing arm actuator 237. All of these actuators may be part of hydraulic system 300, as will be explained in more detail below. Boom actuator 218 may include a hydraulic actuator, such as a liner hydraulic actuator, coupled between the frame/body 150 of mobile machine 140, and a location along a length of boom assembly 210. Lock actuator 216 may include a linear actuator located, for example, on a top surface of the boom assembly 210. The lock actuator 216 may be actuated to move a locking pin 221 into and out of locking engagement with a lock receiver 222 located on the frame/body 150.

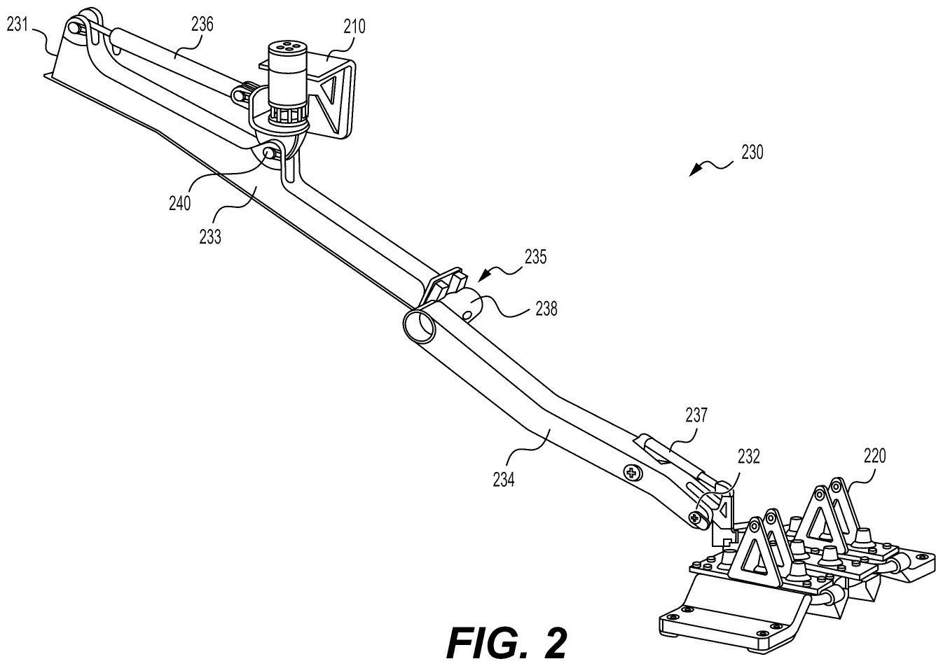

Referring to FIG. 2, the arm assembly 230 of rail connector assembly 200 forms a mechanical and electrical connection between the boom assembly 210 and contactor assembly 220, and may include a first or proximal end 231 connected to an end of the boom assembly 210 and a second or distal end 232 connected to the contactor assembly 220. The arm assembly 230 may be extendable and retractable and may have multiple degrees of freedom to allow for vertical and lateral pivoting about the boom assembly 210. In the exemplified embodiment, the arm assembly 230 may include two portions, an upper portion or arm 233 and a lower portion or arm 234, that are pivotally connected by a central joint 235. Also, upper arm 233 may include a pivot 240 where the upper arm 233 connects to boom assembly 210.

As noted above, the arm assembly 230 may include a plurality of hydraulic actuators 236, 237, 238 including one or more linear actuators and/or one or more rotary hydraulic actuators that move and positon the arm assembly 230. For example, the upper trailing arm actuator 236 may be a liner actuator that controls vertical positioning of upper arm 233. Middle trailing arm actuator 238 may be a 180 degree rotary hydraulic actuator that is coupled between upper and lower arms 233 and 234 at central joint 235, and controls movement of the upper arm 233 vertically with respect to lower arm 234 between a collapsed position where the upper and lower arms 233 and 234 are folded against each other, to an extended or deployed position as shown in FIG. 2. Finally, lower trailing arm actuator 237 may include a linear actuator that controls the orientation of the contactor assembly 220, such as adjusting its pitch. As seen in FIG. 2, the upper trailing arm actuator 236 may be located at the first or proximal end 231 of the arm assembly 230 and the lower trailing arm actuator 237 may be located at the second or distal end 232 of the arm assembly 230.

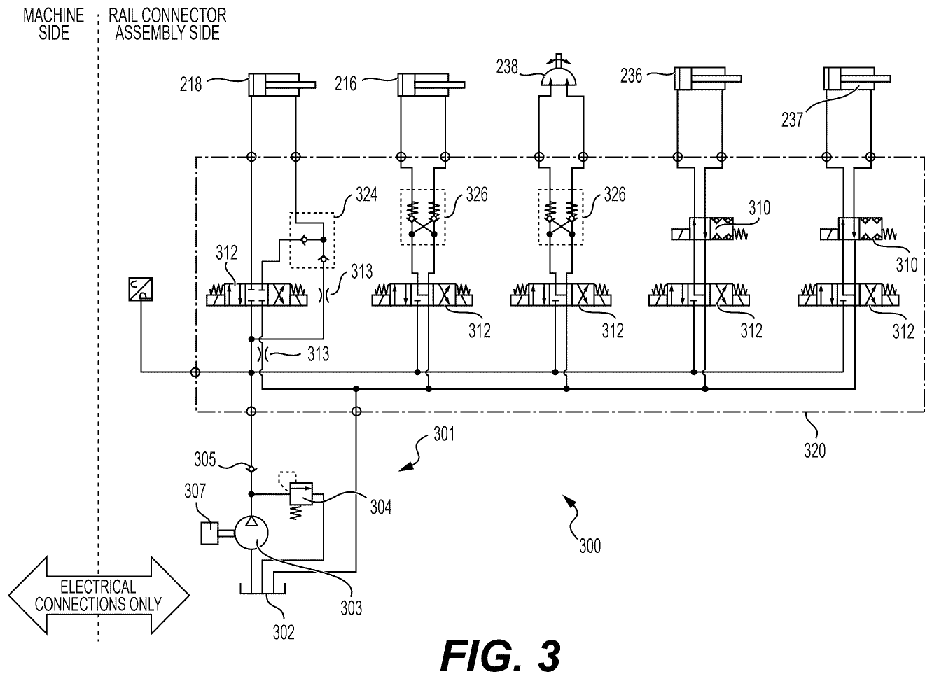

Referring now to FIG. 3, the hydraulic system 300 controls various movements and functions within the rail connector assembly 200. For example, the hydraulic system 300 may extend and/or retract the boom assembly 210 outward from the mobile machine 140 about the pivot joint and along a generally horizontal direction. In addition, the hydraulic system 300 may extend and/or retract the arm assembly 230 and adjust the pitch of the contact assembly 220.

As noted above, the hydraulic system 300 may generally include a hydraulic power unit (HPU) 301, the various hydraulic actuators (216, 218, 238, 236, 237) associated with rail connector assembly 200, and a valve manifold 320 for controlling hydraulic fluid to and from the actuators. Also as noted above, all components of the hydraulic system 300 may be located within the rail connector assembly 200. Thus, the only required connection between the mobile machine 140 (the “machine side”) and the rail connector assembly 200 is the electrical connections to provide power/current, and data/signal exchange between the mobile machine 140 and the rail connector assembly 200. As noted above, this self-contained type arrangement, requiring minimal reconfiguration of the mobile machine 140, may assist in adopting the same, or substantially the same, rail connector assembly 200 on machines having different designs, such as different sizes, types, etc.

The HPU 301 may include a compact unit that generates hydraulic power for the hydraulic system 300. HPU 301 may include a motor 307 driving a pump 303, such as a fixed displacement gear pump, a fluid reservoir or tank 302, and other appropriate components such as a pressure relief valve or regulator 304 and a check valve 305. HPU 301 may be configured to help ensure the delivery and maintenance of pressure in the hydraulic system 300, including providing pressurized hydraulic fluid to the plurality of hydraulic actuators (216, 218, 236, 237, 238). Together, the components that comprise the HPU 301 deliver pressurized fluid to the hydraulic manifold 320 through one or more hydraulic lines.

The hydraulic manifold 320 may include a flow control valve 312 associated with each of the hydraulic actuators, namely the boom actuator 218, lock actuator 216, upper trailing arm actuator 236, middle trailing arm actuator 238, and lower trailing arm actuator 237. The flow control valves 312 can include any appropriate configuration, such as the on/off, solenoid actuated valves shown in FIG. 3. One or more of the flow control vales 312 could be a proportional-type valve.

The flow control valve 312 associated with boom actuator 218, may include a cylinder lock position (valve position shown in FIG. 3) that prohibits the boom actuator 218 from moving. Further, the hydraulic lines associated with boom actuator 218 may include a check valve arrangement 324 that provides a regenerative circuit by diverting rod end fluid to the head end of the cylinder. Such a regenerative circuit may assist in reducing the demand on the pump 303, and may provide for faster cylinder extension. In addition, the hydraulic lines associated with the boom actuator 218 may include one or more orifices 313 that create appropriate back pressure in the hydraulic lines to assist in controlling the speed of the boom actuator 218 and help prevent jerking movements of the boom actuator 218.

The flow control circuit associated with boom lock actuator 216 may include a pilot operated check valve arrangement 326 to hold the boom lock actuator 216 in place when the control valve 312 is in an off position as shown in FIG. 3. The pilot operated check valve arrangement 326, along with a tank connection through flow control valve 312, allows flow of hydraulic fluid into one side of the boom lock actuator 216 when either side of the actuator is at a lower pressure than tank pressure. The flow control circuit associated with the middle trailing arm actuator 238 may similarly include a pilot operated check valve arrangement 326 and flow control valve 312 that connects the pilot operated check valve arrangement 326 with tank pressure. Accordingly, the flow control circuit associated with the middle trailing arm actuator 238 may operate in a similar manner, but in association with a rotary hydraulic actuator rather than the linear hydraulic actuator of the boom lock actuator 216. It is noted that the pilot operated check valve arrangement 326 of the middle trailing arm actuator 238 may be integrated into the middle trailing arm actuator 238 itself, rather than being provided as a separate arrangement within the manifold 320.

The flow control circuit associated with the upper trailing arm actuator 236 may include a separate float valve 310. Separate float valve 310 may be a solenoid operated two-position valve movable between a float position (shown in FIG. 3) and a locked position. In the float position, the flow control valve 312 connects the two ends of the upper trailing arm actuator 236 together and to tank 302. This float arrangement allows the trailing arm actuator to move when acted on by external forces. The flow control circuit associated with the lower trailing arm 237 may also include a separate float valve 310 and flow control valve 312 that can connect the two ends of the lower trailing arm actuator together and to tank 302. While the hydraulic circuit 300 includes two float valves 310, one associated with each of the upper trailing arm actuator 236 and one associated with the lower trailing arm actuator 237, it is understood that only one float valve could be included in the system, either only associated with the upper trailing arm actuator 236 or only associated with the lower trailing arm actuator 237. Even further, the float valve 310 could alternatively be associated with the middle trailing arm actuator 236 rather than the upper trailing arm actuator 236.

### INDUSTRIAL APPLICABILITY

The disclosed aspects of the hydraulic system 300 can be used for deploying and controlling a rail connector assembly that provides current to a free-steering mobile machine with an electrically-conducting rail system on a worksite.

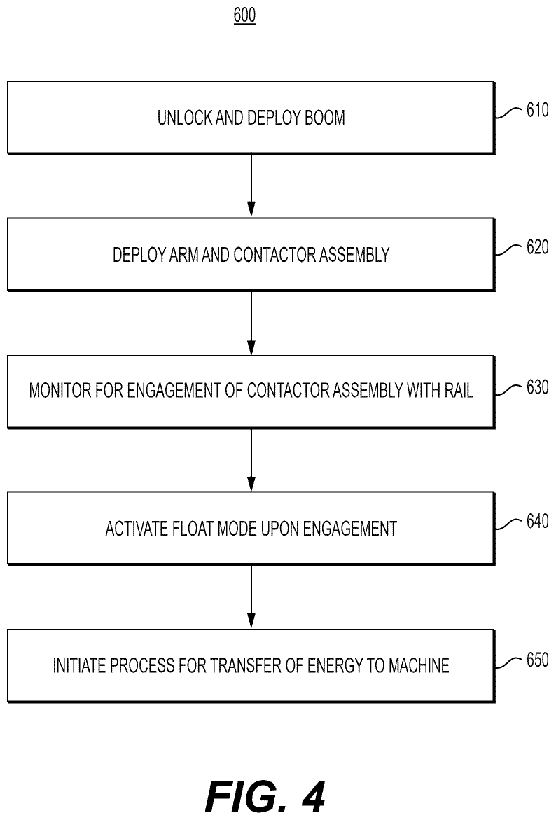

FIG. 4 is a flowchart illustrating an exemplary method 600 for operating a rail connector assembly 200 of a mobile machine power system 100 according to aspects of the present disclosure. Prior to the performance of method 600, the rail connector assembly 200 may be in a stowed and locked state against a side of the frame/body 150, such that boom assembly 210 extends generally parallel and adjacent the side of the mobile machine 140. Further, in this stowed and locked state, the arm assembly 230 may be positioned such that upper and lower arms 233 and 234 folded against one another and the contactor assembly 220 is magnetically coupled to the upper arm 233 of arm assembly 230.

Step 610 may include unlocking and extending or deploying the boom assembly 210 from the stowed position against the mobile machine 140 to an extended or deployed position shown in FIG. 1. For example, the system may receive a request to extend the rail connector assembly 200 to a deployed position that is suitable for engaging with electricity-conducting rail system 120. The request to extend the rail connector assembly 200 may be a single request generated by an operator, for example, pushing a button in the operator cabin 160 or may be automatically generated based on a geographic location of the machine 140 as determined by a Global Navigation Satellite System (“GNSS”). In response to this request, the flow control valves 312 may be turned to an on position with respect to both the boom lock actuator 216 and the boom actuator 218, thus unlocking the boom assembly 210 and extending the boom assembly 210 away from the side of the mobile machine 140. The step 610 of unlocking and deploying boom assembly 210 may also include the actuation of the flow control valve 312 associated with the lower trailing arm actuator 237 to pivot contactor assembly 220 away from mobile machine 140 to magnetically decouple the contactor assembly 220 from upper arm 233. Also, the regenerative circuit associated with check valve arrangement 324 may be active during the movement of the boom assembly 210 to the deployed position, thereby assisting in reducing the demand on the pump 303. Once the boom is in the deployed position (FIG. 1), the control valve 312 associated with boom actuator 218 may be commanded to move to a hydraulic lock position (the position shown in FIG. 3) to secure the boom assembly 210 in the deployed position. Similarly, the flow control valve 312 associated with the lock actuator 216 may be moved to the hold position shown in FIG. 3 to hold the lock in a retracted or unlocked position.

Concurrently with, or immediately after the unlocking and extending of boom assembly 210 to the deployed position in step 610, the arm assembly 230 and contactor assembly 220 may be moved the deployed position shown in FIGS. 1 and 2 (step 620). This may include actuation of the flow control valve 312 associated with the upper trailing arm actuator 236 to the on position to move the piston towards the cap end. This will cause the end 231 of the arm assembly 230 to raise, and the central joint 235 to lower vertically based on pivot 240. During this movement, the flow control valve 312 associated with middle arm assembly actuator 238 may be in the hold position shown in FIG. 3. When upper trailing arm actuator 236 has moved the upper arm 233 to the deployed position (FIGS. 1 and 2), the flow control valve 312 associated with the upper trailing arm actuator 236 may be actuated to the hold position shown in FIG. 3, and the float valve 310 associated with the upper trailing arm may be actuated to the lock position isolating the upper trailing arm actuator 236 in position. During or after movement of the upper arm 233 to the deployed position, lower trailing arm actuator 237 may be actuated to position the contactor assembly 220 to the deployed position, such as the position shown in FIG. 2. Thereafter, the lower arm assembly actuator 237 may be locked in position via the flow control valve 312 associated with the lower trailing arm actuator 237, and the associated float valve 310. Finally, step 620 may include actuating, then holding the middle arm assembly actuator 238 so that the lower arm 234 is extended farther away from upper arm 233 and provides the generally linear arrangement shown in FIG. 2.

With the arm assembly 230 in the deployed position as shown in FIG. 2, method 600 may monitor for when the contactor assembly 220 first contacts or engages with the rails 122 of the rails system 120 (step 630). This contact or engagement may be sensed in any appropriate manner, such as by pressure or position sensors associated with one or more of the trailing arm actuators 236, 237, 238, and/or one or more visual or proximity sensors. Upon sensing when the contactor assembly 220 contacts rails 122, hydraulic system 300 may activate a float mode of the arm assembly 230 (step 640). Float mode may include actuating both float valves 310 into the float position (as shown in FIG. 3), so that the upper trailing arm actuator 236 and lower trailing arm actuator 237 are in a float condition allowing hydraulic fluid to flow between the rod and cap ends of the respective linear hydraulic actuator (236, 237). This float mode helps to maintain contactor assembly 220 in contact with the rails 122 of the rail system 120 when the mobile machine experiences vertical undulations during travel. The two degrees of freedom provided by the float mode allows compensation for both the upper arm 233 and the contactor assembly 220, which can be beneficial when the rail connection assembly 200 experiences sudden vertical movement, such as based on mobile machine 104 traversing bumps or undulations, or the rail system 120 itself has vertical bumps or undulations. It is understood, however, that the float mode could be limited to float of only one of the upper trailing arm actuator 236 or the lower trailing arm actuator 237. Further, a float mode could include actuating a float valve 310 (not shown) associated with the middle trailing arm actuator 238 to a float position, instead of a float valve 310 associated with the upper trailing arm actuator 236. It is understood, however that the number of float valves 310 on arm assembly 230 may be limited to only two float valves 310 because actuating the arm assembly 230 into three degrees of freedom with three float valve 310 may provide a trailing arm 230 with insufficient stiffness.

In an alternative arrangement, instead of monitoring for contact of the contactor assembly 220 with the conductor rails 122 (step 630), the deployed position of the arm assembly 230 and contactor assembly 220 (FIGS. 1 and 2) may be at their predefined lower limits. In such a case, the arm assembly 230 and the contactor assembly 220 may remain in the deployed position even upon actuation of one or both of the float valves 310. In this arrangement there is no need to sense or monitor contact with the conductor rails 122, and the float valves 310 can be energized to the float positon once the arm assembly 230 and contactor assembly 220 are in the deployed position, and prior to any contact of the contactor assembly 220 with the conductor rails 122.

Once the contactor assembly 220 is in contact or engagement with the rails 122, and the arm assembly 230 is in float mode, the rail connector assembly 200 can initiate a process for transferring energy from the rails 122 to the mobile machine 140 (step 650). Such a process can include various confirmations or checks before engaging the electrical conductor terminals of the contactor assembly 220 with the rail 122 and conveying current along the rail connector assembly 200 to one or more motors 144 or the battery system 146 of the mobile machine 140.

In accordance with the present disclosure, the hydraulic system 300 associated with the rail connector assembly 200 may provide assistance in maintaining contact between the arm assembly 230 and the rails 122 of the electricity-conducting rail system 120, even when the mobile machine 140 experiences undesired undulations.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A rail connector assembly for an electrically powered mobile machine, comprising:
a boom assembly with a first end and a second end;
an arm assembly movable between a stowed condition and a deployed condition, the arm assembly having a first end coupled to the boom, and a second end;
a contactor assembly coupled to the second end of the arm assembly; and
a hydraulic system controlling movement of the rail connector assembly, the hydraulic system including:
a hydraulic power unit;
a plurality of hydraulic actuators fluidly driven by the hydraulic power unit; and
at least one float valve fluidly connected to at least one of the plurality of hydraulic actuators.

2. The rail connector assembly of claim 1, wherein the plurality of hydraulic actuators includes:
a first linear actuator for moving the arm assembly, and
a second linear actuator for moving the contactor assembly.

3. The rail connector assembly of claim 2, wherein the at least one float valve is fluidly coupled to the first linear actuator.

4. The rail connector assembly of claim 2, wherein the at least one float valve is fluidly coupled to the second linear actuator.

5. The rail connector assembly of claim 2, wherein the at least one float valve includes a first float valve and a second float valve, the first float valve is fluidly coupled to the first linear actuator, and the second float valve is fluidly coupled to the second linear actuator.

6. The rail connector assembly of claim 5, wherein the first and second float valves control float of the connector assembly in a vertical direction.

7. The rail connector assembly of claim 2, wherein the plurality of hydraulic actuators further includes a rotary hydraulic actuator located between the first and second linear actuators along the arm assembly.

8. The rail connector assembly of claim 1, wherein the at least one float valve is separate from a control valve fluidly controlling the at least one hydraulic actuator.

9. The rail connector assembly of claim 8, wherein the float valve is separate from the at least one hydraulic actuator and fluidly located between the control valve and the at least one hydraulic actuator.

10. The rail connector assembly of claim 1, wherein the hydraulic power unit, the plurality of hydraulic actuators, and the at least one float valve are all located in the rail connector assembly, and the rail connector assembly is pivotable with respect to the frame of the electrically powered mobile machine.

11. A rail connector assembly for an electrically powered mobile machine, comprising:
a boom assembly with a first end and a second end;
an arm assembly movable between a stowed condition and a deployed condition, the arm assembly having a first end coupled to the boom, and a second end;
a contactor assembly coupled to the second end of the arm assembly; and
a hydraulic system controlling movement of the rail connector assembly, the hydraulic system including:
a plurality of hydraulic actuators coupled to the arm assembly and fluidly driven by the hydraulic power unit; and
at least one float valve fluidly connected to at least one of the plurality of hydraulic actuators for allowing float in a vertical direction.

12. The rail connector assembly of claim 11, wherein the plurality of hydraulic actuators includes:
a first linear actuator for moving the arm assembly, and
a second linear actuator for moving the contactor assembly.

13. The rail connector assembly of claim 12, wherein the at least one float valve is fluidly coupled to the first linear actuator.

14. The rail connector assembly of claim 12, wherein the at least one float valve is fluidly coupled to the second linear actuator.

15. The rail connector assembly of claim 12, wherein the at least one float valve includes a first float valve and a second float valve, the first float valve is fluidly coupled to the first linear actuator, and the second float valve is fluidly coupled to the second linear actuator.

16. The rail connector assembly of claim 12, wherein the plurality of hydraulic actuators further includes a rotary hydraulic actuator located between the first and second linear actuators along the arm assembly.

17. The rail connector assembly of claim 12, wherein the float valve is separate from the at least one hydraulic actuator and a control valve fluidly connected to the at least one hydraulic actuator, and the float valve is located between the at least one hydraulic actuator and the control valve.

18. A method of operating a rail connector assembly of an electrically powered mobile machine, the rail connector assembly including a boom assembly with a first end and a second end; an arm assembly movable between a stowed condition and a deployed condition, the arm assembly having a first end coupled to the boom, and a second end; a contactor assembly coupled to the second end of the arm assembly, the method including:
moving the boom assembly from a retracted position to deployed position;
moving the arm assembly from a retracted position to a deployed position using a plurality of hydraulic actuators; and
placing at least one of the plurality of hydraulic actuators in a float condition based on a position of the conductive rail assembly.

19. The method of claim 18, wherein the plurality of hydraulic actuators includes three hydraulic actuators located on the arm assembly, and the placing of at least one of the plurality of hydraulic actuators in a float condition includes placing a plurality of the hydraulic actuators in a float condition.

20. The method of claim 19, wherein the position of the conductive rail assembly is a deployed position of the conductive rail assembly prior to contact of the contactor assembly with an electrically-conductive rail system.
